(19) United States
(12) Patent Application Publication
(10) Pub. No.: US 2021/0312580 A1
(43) Pub. Date: Oct. 7, 2021

(54) METHOD AND SYSTEM FOR DISTRIBUTING INFORMATION RELATING TO SANCTIONS

(71) Applicant: JPMorgan Chase Bank, N.A., New York, NY (US)

(72) Inventors: Samuel Kanor Kudaya, Geneva (CH); Milosz Krawiec, Glasgow (GB); Stefano Petrucco, Geneva (CH); Eric Bourdin, Reignier (FR)

(73) Assignee: JPMorgan Chase Bank, N.A., New York, NY (US)

(21) Appl. No.: 17/220,328

(22) Filed: Apr. 1, 2021

Related U.S. Application Data
(60) Provisional application No. 63/003,978, filed on Apr. 2, 2020.

(51) Int. Cl. G06Q 50/26; G06Q 40/02

(52) U.S. Cl. CPC G06Q 50/265; G06Q 20/389; G06Q 40/02

(57) ABSTRACT

A method and computing apparatus for distributing information relating to sanctions are provided. The method includes receiving, from a governmental source, first information relating to at least one sanctioned entity, arranging the first information according to a predetermined format, distributing the arranged information to a plurality of financial institutions, providing a user interface displaying the first information, prompting a user to input second information via the user interface, receiving the second information, arranging the second information according to the predetermined format, and distributing the arranged second information to the plurality of financial institutions.

### CROSS-REFERENCE TO RELATED APPLICATIONS

This application claims the benefit of U.S. Provisional Patent Application Ser. No. 63/003,978, filed Apr. 2, 2020, which is hereby incorporated by reference in its entirety.

### BACKGROUND

### 1. Field of the Disclosure

This technology generally relates to methods and systems for distributing consistent and up-to-date information relating to sanctions.

### 2. Background Information

One problem encountered by an organization, e.g., a financial institution, is an inability to efficiently and accurately make decisions relating to sanctioned entities. Typically, a sanction list is used by an organization, e.g., a financial institution, in an effort to prevent the organization from doing business with a sanctioned entity, i.e., a criminal entity. Each financial institution has traditionally spent time and money to build its own sanction list from various sources such as, e.g., the United States Office of Foreign Assets Control (OFAC).

In many instances, a financial institution often may not have the same sanction list information as other financial institutions, and when financial institutions do business together such discrepancies in sanction list information can cause reconciliation issues. The discrepancies can also cause inaccuracies or inefficiencies in payments, in due diligence activities, in verification of client identities, in client suitability assessments, in client risk assessments, and in Know Your Customer (KYC) procedures.

Currently, there is no global platform on which organizations can share financial crime data between each other. Without such a platform, financial criminals may exploit the lack of cooperation between financial organizations.

In addition, financial institutions may unknowingly do business with sanctioned entities and/or fail to detect fraud, money laundering, sanction evasion, and other financial crimes.

Accordingly, there is a need to efficiently and accurately distribute consistent and up-to-date information relating to sanctions, e.g., by sharing a consistent and updated version of information relating to sanctioned entities and allowing participants to contribute additional information relating to sanctioned entities.

### SUMMARY

The present disclosure, through one or more of its various aspects, embodiments, and/or specific features or sub-components, provides, inter alia, various systems, servers, devices, methods, media, programs, and platforms for distributing information relating to sanctions.

According to an exemplary embodiment, a method for distributing information relating to sanctions is provided. The method is implemented by at least one processor. The method includes: receiving, from a governmental source, first information relating to at least one sanctioned entity; arranging the first information according to a predetermined format; and distributing the arranged first information to a plurality of financial institutions.

The method for distributing information relating to sanctions may further include providing a user interface displaying the first information; prompting a user to input second information that relates to the at least one sanctioned entity via the user interface; receiving the second information; arranging the second information according to the predetermined format; and distributing the arranged second information to the plurality of financial institutions.

In the method for distributing information relating to sanctions, the second information may include information relating to, e.g., at least one image associated with the sanctioned entity, at least one International Bank Account Number (IBAN) associated with the sanctioned entity, a passport number associated with the sanctioned entity, a country of residence of the sanctioned entity, or a combination of such.

In the method for distributing information relating to sanctions, a sanctioned entity may be an individual person, and the first information relating to the sanctioned entity may relate to, e.g., a name, an alias, at least one citizenship, a country of birth, a city of birth, an address, a date of birth of the individual person, or a combination of such.

In the method for distributing information relating to sanctions, a sanctioned entity may be an organization and the first information relating to the at least one sanctioned entity may include at least a name of the organization.

In the method for distributing information relating to sanctions, the arranging the first information may include adding the information to a decentralized distributed ledger.

In the method for distributing information relating to sanctions, the arranging of the first information may include using blockchain technology to arrange the first information.

In the method for distributing information relating to sanctions, the first information may include, e.g., a list of sanctioned entities, a sanction list, a black list of crypto wallets, or a combination of such.

In the method for distributing information relating to sanctions, the governmental source may include, e.g., the United States Office of Foreign Asset Control (OFAC), the State Secretariat for Economic Affairs (SECO), or a combination of such.

According to another exemplary embodiment, a computing apparatus for generating a user interface for distributing information relating to sanctions is provided. The computing apparatus includes a processor; a memory; and a communication interface coupled to each of the processor and the memory. The processor is configured to: receive, from a governmental source, first information relating to at least one sanctioned entity; arrange the first information according to a predetermined format; and distribute the arranged first information to a plurality of financial institutions.

The processor may be further configured to: provide a user interface displaying the first information; prompt a user to input second information that relates to the at least one sanctioned entity via the user interface; receive the second information; arrange the second information according to the predetermined format; and distribute the arranged second information to the plurality of financial institutions.

In association with the computing apparatus, the second information may include information relating to, e.g., at least one image associated with the sanctioned entity, at least one International Bank Account Number (IBAN) associated with the sanctioned entity, a passport number associated with the sanctioned entity, a country of residence of the sanctioned entity, or a combination of such.

In association with the computing apparatus, a sanctioned entity may be an individual person and the information relating to the sanctioned entity may include, e.g., a name, an alias, at least one citizenship, a county of birth, a city of birth, an address, a date of birth of the individual person, or a combination of such.

In association with the computing apparatus, a sanctioned entity may be an organization and the first information relating to the at least one sanctioned entity may include at least a name of the organization.

In association with the computing apparatus, the arranging of the first information may include adding the information to a decentralized distributed ledger.

In association with the computing apparatus, the arranging of the first information may include using blockchain technology to arrange the first information.

In association with the computing apparatus, the first information may include, e.g., a list of sanctioned entities, a sanction list, a black list of crypto wallets, or a combination of such.

In association with the computing apparatus, the governmental source may include, e.g., the United States Office of Foreign Asset Control (OFAC), the State Secretariat for Economic Affairs (SECO), or a combination of such.

According to yet another exemplary embodiment, a non-transitory computer readable storage medium storing instructions for generating a user interface for distributing information relating to sanctions is provided. The storage medium includes executable code which, when executed by a processor, causes the processor to: receive, from a governmental source, first information relating to at least one sanctioned entity; arrange the first information according to a predetermined format; and distribute the arranged first information to a plurality of financial institutions.

When executed by the processor, the executable code may further cause the processor to: provide a user interface displaying the first information; prompt a user to input second information that relates to the at least one sanctioned entity via the user interface; receive the second information; arrange the second information according to the predetermined format; and distribute the arranged second information to the plurality of financial institutions.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for distributing information relating to sanctions.

FIG. 4 is a flowchart of an exemplary process for implementing a method for distributing information relating to sanctions.

FIG. 5 is a data flow diagram that illustrates an implementation of a method for distributing information relating to sanctions, according to an exemplary embodiment.

FIG. 6 shows a screenshot of a user interface for prompting a user to provide information regarding a sanctioned entity, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

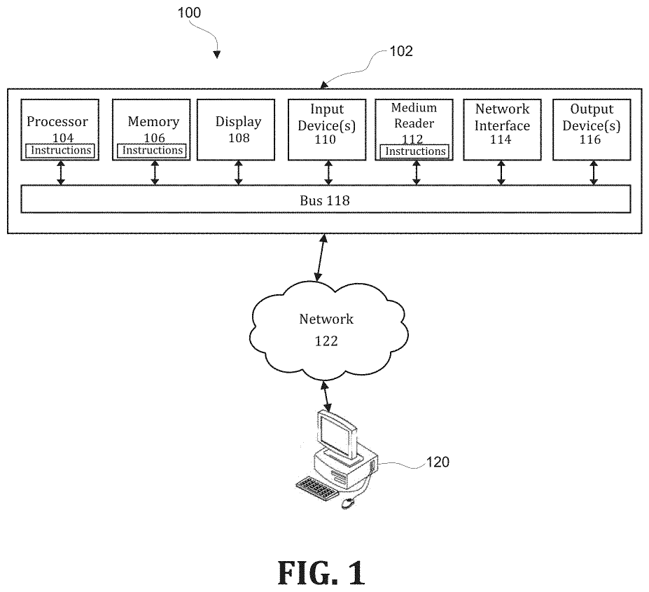

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed. processing, and parallel processing. Virtual computer system processing can he constructed to implement one or more of the methods or functionality as described herein, and a processor described herein may be used to support a virtual processing environment.

As described herein, various embodiments provide optimized methods and systems for distributing information relating to sanctions.

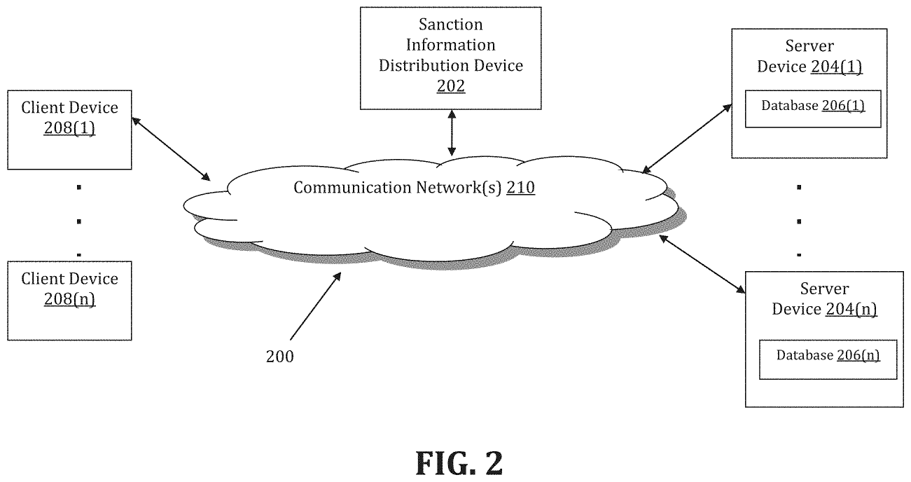

Referring to FIG. 2, a schematic of an exemplary network environment 200 for implementing a method for distributing information relating to sanctions is illustrated. In an exemplary embodiment, the method is executable on any networked computer platform, such as, for example, a personal computer (PC).

The method for distributing information relating to sanctions may be implemented by a Sanction Information Distribution (SID) device 202. The SID device 202 may be the same or similar to the computer system 102 as described with respect to FIG. 1. The SID device 202 may store one or more applications that can include executable instructions that, when executed by the SID device 202, cause the SID device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the SID device 202 itself, may be located in virtual server(s) running in a cloud-based computing environment rather than being tied to one or more specific physical network computing devices. Also, the application(s) may be running in one or more virtual machines (VMs) executing on the SID device 202.

Additionally, in one or more embodiments of this technology, virtual machine(s) running on the SID device 202 may be managed or supervised by a hypervisor.

In the network environment 200 of FIG. 2, the SID device 202 is coupled to a plurality of server devices 204(1)-204(n) that hosts a plurality of databases 206(1)-206(n), and also to a plurality of client devices 208(1)-208(n) via communication network(s) 210. A communication interface of the SID device 202, such as the network interface 114 of the computer system 102 of FIG. 1, operatively couples and communicates between the SID device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the SID device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and SID devices that efficiently implement a method for distributing information relating to sanctions.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The SID device 202 may be a standalone device or integrated with one or more other devices or apparatuses, such as one or more of the server devices 204(1)-204(n), for example. In one particular example, the SID device 202 may include or be hosted by one of the server devices 204(1)-204(n), and other arrangements are also possible. Moreover, one or more of the devices of the SID device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the SID device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to distributing information relating to sanctions.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the SID device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the SID device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the SID device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the SID device 202, the server devices 204(1)-204(n), or the client devices 208(1)-208(n), for example, may be configured to operate as virtual instances on the same physical machine. In other words, one or more of the SID device 202, the server devices 204(1)-204(n), or the client devices 208(1)-208(n) may operate on the same physical device rather than as separate devices communicating through communication network(s) 210. Additionally, there may be more or fewer SID devices 202, server devices 204(1)-204(n), or client devices 208(1)-208(n) than illustrated in FIG. 2.

In addition, two or more computing systems or devices may be substituted. for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

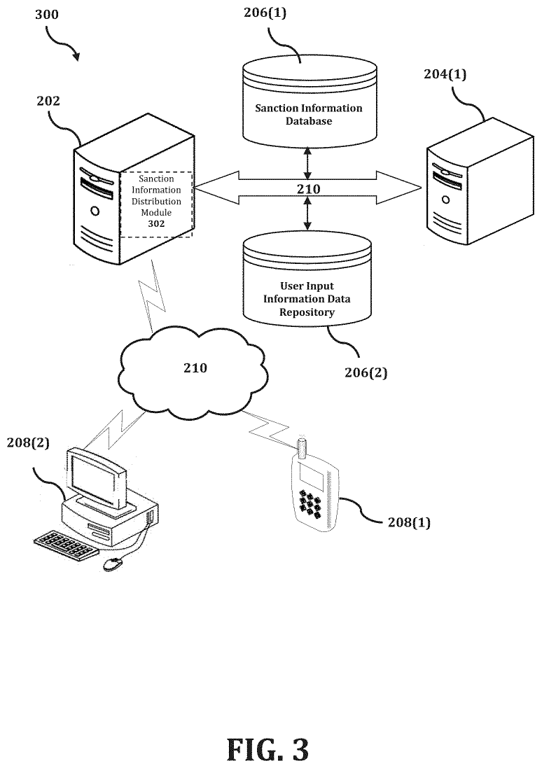

The SID device 202 is described and shown in FIG. 3 as including a Sanction Information Distribution module 302, although it may include other rules, policies, modules, databases, or applications, for example. As will be described below, the Sanction Information Distribution module 302 is configured to implement a method for distributing information relating to sanctions.

An exemplary process 300 for implementing a mechanism for distributing information relating to sanctions by utilizing the network environment of FIG. 2 is shown as being executed in FIG. 3. Specifically, a first client device 208(1) and a second client device 208(2) are illustrated as being in communication with SID device 202. In this regard, the first client device 208(1) and the second client device 208(2) may be “clients” of the SID device 202 and are described herein as such. Nevertheless, it is to be known and understood that the first client device 208(1) and/or the second client device 208(2) need not necessarily be “clients” of the SID device 202, or any entity described in association therewith herein. Any additional or alternative relationship may exist between either or both of the first client device 208(1) and the second client device 208(2) and the SID device 202, or no relationship may exist.

According to an exemplary embodiment, client devices 208(1)-208(n) may be embodied by or related to a plurality of user devices. In an exemplary embodiment, a user device of the plurality of user devices may be associated with at least one individual of an organization. In another exemplary embodiment, a user device of the plurality of user devices may be associated with at least one group of individuals of the organization. In yet another exemplary embodiment, a user device of the plurality of user devices may be associated with a location such as, e.g., an organization's headquarters, an organization's corporate office, an organization's retail location, an organization's sales office, an organization's administrative office, an organization's field office, or a home office of an individual of an organization.

In an exemplary embodiment, SID device 202 is illustrated as being able to access a sanction information database 206(1) and a user input information data repository 206(2). The Sanction Information Distribution module 302 may be configured to access these databases for implementing a method for distributing information relating to sanctions.

The first client device 208(1) may be, for example, a personal computer (PC). Of course, the first client device 208(1) may be any additional device described herein. The second client device 208(2) may be, for example, a smart phone. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the SID device 202 via broadband or cellular communication. Of course, these embodiments are merely exemplary and are not limiting or exhaustive.

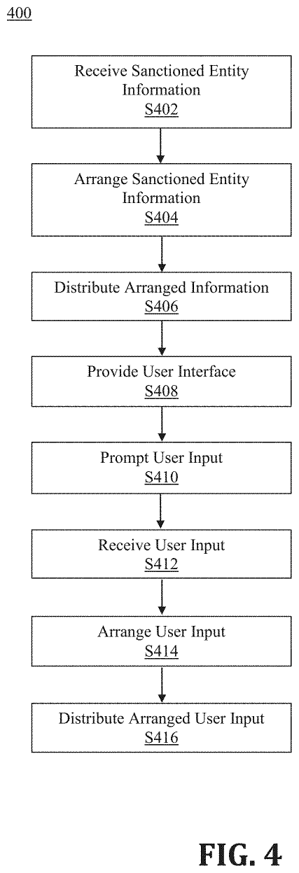

Upon being started, the Sanction Information Distribution module 302 executes a process for distributing information relating to sanctions. An exemplary process for distributing information relating to sanctions is generally indicated at flowchart 400 in FIG. 4.

In the process 400 of FIG. 4, at step S402, the Sanction Information Distribution module 302 receives first information, i.e., information relating to at least one sanctioned entity.

In an exemplary embodiment, the information relating to sanctioned entities may include a list of sanctioned entities or a sanction list. In an exemplary embodiment, the information relating to the sanctioned entity includes a black list of crypto wallets. The information relating to at least one sanctioned entity may be received from an official source.

In an exemplary embodiment, the official source may be a governmental source. The official source may be at least one of the United States Office of Foreign Asset Control (OFAC) and the State Secretariat for Economic Affairs (SECO); however, the official source may be one of many organizations or governmental sources in the world that is trusted to provide information relating to at least one sanctioned entity.

In an exemplary embodiment, a sanctioned entity is an entity that is generally prohibited or restricted from engaging in trade or financial transactions in a particular jurisdiction. Entities (such as, e.g., financial institutions such as, e.g., a bank or a credit union) may be required to comply with governmental regulations relating to sanctioned entities. An entity may be penalized, e.g., fined, by a government for violating one of such regulations.

In an exemplary embodiment, a sanctioned entity may include a terrorist individual or a terrorist organization. In another exemplary embodiment, a sanctioned entity may include a convicted or suspected narcotics trafficker or may include an organization that is or may be involved in narcotics trafficking.

In an exemplary embodiment, a sanctioned entity may one of an individual person, a country, a company, an organization, or a group of individuals. In an exemplary embodiment, the first information or the information relating to the at least one sanctioned entity may include at least one of a name, an alias, a passport number, a national identification number, a nationality, a citizenship, a role in an organization, a date of birth, a country of birth, a gender, a website, and an address. In another exemplary embodiment, the first information or the information relating to the at least one sanctioned entity may relate to any information that may identify the sanctioned entity.

At step S404, the Sanction Information Distribution module 302 arranges the first information or the information relating to the sanctioned entities according to a predetermined format.

In an exemplary embodiment, the arranging of the first information or information relating to the at least one sanctioned entity includes adding the first information to a decentralized distributed ledger and/or a transaction ledger. In an exemplary embodiment, the arranging may be performed by using blockchain technology, or by using a consensus algorithm.

In an exemplary embodiment, the arranging of the information relating to the at least one sanctioned entity includes adding the information relating to the at least one sanctioned entity to an immutable record, or to a distributed ledger that exists on a peer-to-peer network. In another embodiment, the arranging may include verifying the information relating to the at least one sanctioned entity by a plurality of peers on the peer-to-peer network. The information that exists on the peer-to-peer network may not be under control by one central authority, and control of the information that exists on the peer-to-peer network may be shared by peers of the peer-to-peer network.

In an exemplary embodiment, any individual or organization can join the peer-to-peer network. Peers of the peer-to-peer network may not be charged a fee to become or maintain a peer in the peer-to-peer network. Further, the peers of the peer-to-peer network may not have management rights.

In an alternative exemplary embodiment, there is an administrator of the peer-to-peer network that selectively provides authorization for an individual or organization to become or maintain a peer in the peer-to-peer network. For example, at least one organization, e.g., a financial institution, may be the administrator of the peer-to-peer network. At least one individual or organization may pay a fee to become or maintain a peer in the peer-to-peer network. A peer of the peer-to-peer network may include at least one of an individual, a financial institution, a law enforcement agency, a governmental regulator, a governmental source, and an official source. The law enforcement agency may be at least one of the Central Intelligence Agency (CIA), the Federal Bureau of Investigation (FBI), and Interpol. The law enforcement agency may contribute directly to information relating to at least one sanctioned entity.

In an exemplary embodiment, an administrator of the peer-to-peer network provides access control management. The administrator may control which peers are authorized to access, add, change, and/or delete information that exists on the peer-to-peer network.

In an exemplary embodiment, an administrator of the peer-to-peer network may authorize a peer to access all of or a subset of the information that exists on the peer-to-peer network. In an exemplary embodiment, a subset of information existing on the peer-to-peer network may be available publicly. The administrator may limit the amount of information that a peer may access, change, add, and/or delete. The administrator may also be a peer of the peer-to-peer network.

In an exemplary embodiment, the information that exists on the peer-to-peer network is immutable. Peers of the peer-to-peer network may only be able to access existing information or add information to existing information on the peer-to-peer network.

At step S406, the Sanction Information Distribution module 302 distributes the arranged information relating to the sanctioned entities. In an exemplary embodiment, the information is distributed to a plurality of organizations, including but not limited to financial institutions.

In an exemplary embodiment, the arranged first information is distributed to a financial institution such that the financial institution has access to information relating to sanctioned entities, and therefore the financial institution can use such information to prevent or reduce fraud, money laundering, sanction evasion, and other financial crimes.

In an exemplary embodiment, the distributing of the arranged first information includes distributing the arranged first information to a plurality of nodes in a network. As a result, the distribution may enable a plurality of organizations to access the arranged information via a node of the plurality of nodes in the network.

In an exemplary embodiment, in addition to receiving information relating to sanctioned entities from at least one official source, additional information relating to sanctioned entities may be received from at least one user. Such a user may be related to a peer of the of the peer-to-peer network.

At step S408, the Sanction Information Distribution module 302 provides a user interface to display the first information or the information relating to the sanctioned entities.

In an exemplary embodiment, the information relating to the at least one sanctioned entity is stored in a decentralized distributed ledger. In this regard, when information regarding at least one sanctioned entity is received, a new block may be added to the decentralized distributed ledger. In an exemplary embodiment, the Sanction Information Distribution module 302 provides high speed data retrieval while maintaining transactional security.

In an exemplary embodiment, the Sanction Information Distribution module 302 is configured to retrieve all of the data in the decentralized distributed ledger in a few seconds, in one second, or in a fraction of a second. The Sanction Information Distribution module 302 may be configured to store a predetermined number of smart contracts, each of which may be included in blocks of the decentralized distributed ledger.

In an exemplary embodiment, a reference smart contract is stored in a predetermined number of first blocks of the decentralized distributed ledger. The reference smart contract may include a list of all addresses that relate to the smart contracts in the decentralized distributed ledger. The reference smart contract may include addresses of sanctioned entities.

Upon accessing the decentralized distributed ledger, the reference smart contract is read first and the transaction time is identified from the reference smart contract. Then content of the decentralized distributed ledger is loaded directly into memory. Accordingly, the information of the decentralized distributed ledger can be retrieved in a few seconds, in one second, or in a fraction of a second.

In an exemplary embodiment, the Sanction Information Distribution module 302 runs on an application operably coupled to a local cache. The local cache may store information of the decentralized distributed ledger. The local cache may be used to retrieve all of the data in the decentralized distributed ledger in a few milliseconds. In an exemplary embodiment, the local cache is updated each time a new block is added to the decentralized distributed ledger.

At step S410, the Sanction Information Distribution module 302 prompts a user to input second information via the user interface. In an exemplary embodiment, the second information is information that relates to at least one sanctioned entity that is input by a user. The second information may include any of a picture, an image associated with the at least one sanctioned entity, a compressed image, an International Business Account Number (IBAN), a name, an alias, a passport number, a national identification number, a nationality, a citizenship, a role in an organization, a date of birth, a country of birth, a gender, a website, and/or an address associated with the at least one sanctioned entity. In this aspect, the second information may include any information that is suitable for identifying the sanctioned entity.

At step S412, the Sanction Information Distribution module 302 receives the second information input via the user interface. In an exemplary embodiment, the receiving of the second information includes a user selecting or entering alphanumeric characters into an input device such as, e.g., a keyboard, keypad, or touchscreen. The receiving of the second information may include using voice recognition technology.

In an exemplary embodiment, the receiving of the second information includes a user using the user interface to select an electronic file, e.g., an image or compressed image associated with the at least one sanctioned entity. For example, the user may click and drag a file from a first portion of a display to a second portion of the display. As another example, the user may click a browse files icon and choose at least one electronic file from a plurality of source files.

In an exemplary embodiment, second information is received from any peer of the peer-to-peer network. Alternatively, second information may only be received from a subset of the peers. For example, the administrator of the peer-to-peer network may control which of the peers are included in the subset. In an exemplary embodiment, the administrator may limit the second information that is received from a peer.

At step S414, the Sanction Information Distribution module 302 arranges the received second information according to the predetermined format. In an exemplary embodiment, the arranging of the second information includes adding the second information to the decentralized distributed ledger. The arranging may be performed using blockchain technology. The arranging may include adding the second information onto a transaction ledger.

In an exemplary embodiment, when the received second information is an image or picture associated with the at least one sanctioned entity, the arranging of the second information includes compressing the file size of the received image or picture associated with the at least one sanctioned entity. For example, the received image or picture may be compressed to a size equal to or less than a predetermined file size, e.g, a size less than twenty kilobytes, such that the received second information can be added to a distributed sequential transactional database and/or shared over a peer-to-peer network. In an exemplary embodiment, the arranged second information is located in a storage trie of a smart contract that is not immutable and is thus compliant with General Data Protection Regulation (GDPR).

In an exemplary embodiment, the arranging of the second information includes adding the second information to the immutable record and/or the distributed ledger that exists on the peer-to-peer network. In another exemplary embodiment, the arranging of the second information includes verifying the second information by the peers on the peer-to-peer network. Further, the arranging of the second information may include using a consensus algorithm.

At step S416, the Sanction Information Distribution module 302 distributes the received second information to at least one entity, e.g., a financial institution. In an exemplary embodiment, the second information is distributed to a plurality of organizations, including but not limited to financial institutions. As a result, these organizations may use the second information to prevent or reduce fraud, money laundering, sanction evasion, and other financial crimes.

In an exemplary embodiment, the arranged second information is distributed to the nodes in the network, thereby enabling each organization to access the arranged second information via a corresponding node.

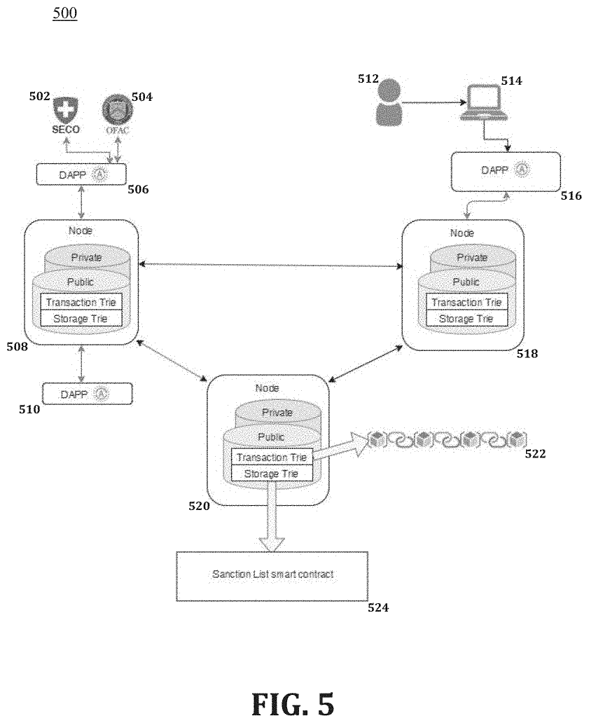

Referring to FIG. 5, a first data flow diagram 500 is shown. According to an exemplary embodiment, a first official source 502 operably communicates with a first Decentralized Application (DAPP) 506. The first official source 502 may be the United States Office of Foreign Assets Control (OFAC). The first DAPP 506 may operate on a decentralized peer-to-peer network. The first DAPP 506 may operably communicate with a second official source 504. The second official source may be the State Secretariat for Economic Affairs (SECO).

In an exemplary embodiment, the first DAPP 506 receives information relating to at least one sanctioned entity (i.e., first information) from at least one of the first official source and the second official source. The information relating to the at least one sanctioned entity may be, for example, in the form of a sanction list. In an exemplary embodiment, the first information received from the first and/or second source is received at the moment the first information is published by the official source; however, the first information may be received before or shortly after the first information is published by the official source. In another exemplary embodiment, the first information is not made public by the official source, e.g, due to security concerns, but the first DAPP 506 nevertheless receives the first information from the official source.

In an exemplary embodiment, the first DAPP 506 operably communicates with a first node 508. The first DAPP 506 may synchronize the received first information in real time. The first node 508 may have at least one of a private storage and a public storage. The public storage of the first node 508 may include at least one of a transaction trie and a storage trie. The transaction trie may be immutable and the storage trie may not be immutable. A smart contract may be associated with the storage trie. The transaction trie may be associated with a distributed sequential transactional database communicatively connected to a network. The first node 508 may operably communicate with a second DAPP 510. The first node 508 may operably communicate with a second node 518 and/or a third node 520.

According to an exemplary embodiment, a user interface provided on an input device 514 prompts a user 512 to enter the second information. The user 512 may be related to an organization, and the organization may be, e.g., at least one of a financial institution, a law enforcement agency, a governmental entity/source, and an official source.

In an exemplary embodiment, the user input device 514 operably communicates with a third DAPP 516. For example, the second information received from the user 512 at the user input device 514 may be transmitted to the third DAPP 516. The third DAPP 516 may operate on a decentralized peer-to-peer network, and the third DAPP 516 may operably communicate with the second node 518. For example, the second information received from the user input device 514 at the third DAPP 516 may be transmitted to the second node 518. The second node 518 may have a private storage and/or a public storage. The public storage of the second node 518 may include a transaction trie and/or a storage trie. The transaction trie may be immutable and the storage trie may not be immutable. A smart contract may be associated with the storage trie, and the transaction trie may be associated with the distributed sequential transactional database communicatively connected to the network. The second node 518 may operably communicate with the first node 508 and/or the third node 520.

The third node 520 may operably communicate with the first node 508 and/or the second node 518. In an exemplary embodiment, the third node 520 may receive first information via the first node 508 and/or second information via the second node 518. The third node 520 may have a private storage and/or a public storage. The public storage of the third node 520 may include a transaction trie and/or a storage trie. The transaction trie may be immutable and the storage trie may not be immutable. smart contract may be associated with the storage trie, and the transaction trie may be associated with the distributed sequential transactional database communicatively connected to the network. The transaction trie of the third node 520 may include a transaction ledger 522. The transaction ledger 522 may use a blockchain database and/or a blockchain data structure. The storage trie of the third node 520 may include a Sanction List smart contract 524.

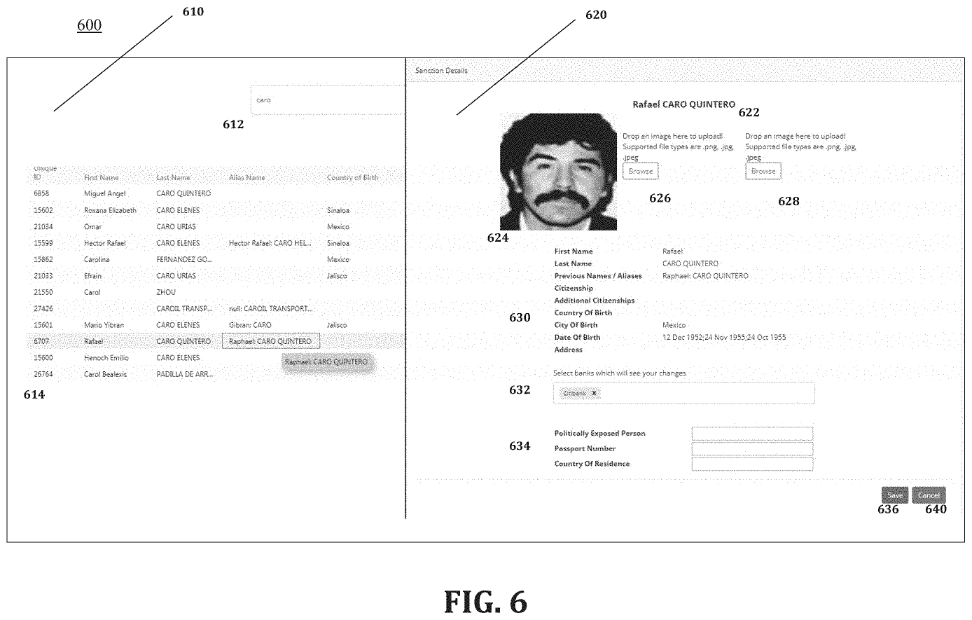

Referring to FIG. 6, a screenshot 600 of a use of interface for prompting a user to provide information regarding a sanctioned entity is shown. In an exemplary embodiment, the user interface is accessible via an Internet browser. In another exemplary embodiment, the user interface is accessible via an application that has been downloaded and/or installed on a computer. In an exemplary embodiment, the user interface includes a list section 610 and a details section 620.

The list section 610 may include a search field 612 and/or a first table 614. The search field 612 may prompt a user to enter all or a portion of at least one descriptive attribute of a sanctioned entity. The descriptive attribute may be any of, e.g., a name, an alias, a passport number, a national identification number, a nationality, a citizenship, a role in an organization, a date of birth, a country of birth, a website, and/or any information that is suitable for identifying the sanctioned entity. The entered descriptive attribute of the sanctioned entity may be displayed on the user interface.

In an exemplary embodiment, after information is entered into the search field 612, the user interface displays a first table 614 that includes search results for the information received in the search field 612. The first table 614 may include information that relates to various attributes a sanctioned entity.

As illustrated in FIG. 6, the first table 614 includes columns for unique identification (ID), first name, last name, alias name, country of birth, city of birth and date of birth. While the information is arranged in columns, the organization of such information is not limited thereto. For example, the information may be arranged in rows, tiles, or any other suitable structure. In an exemplary embodiment, the user interface is configured to display a plurality of attributes, but all attributes need not be visible simultaneously. The user interface may include a means to display alternative and/or additional attributes, e.g., a vertical and/or horizontal scroll bar coupled to the first table 614 to vertically or horizontally access additional rows, columns, tiles, cells, elements, or attributes of the first table 614.

As also illustrated in FIG. 6, the user interface displays the sanctioned entities which relate to the received character string entered into the search field 612. The character string “caro qui” was entered in the search field 612, and as a result, twelve sanctioned entities that have the last name “CARO QUINTERO” are included in first table 614. While twelve sanctioned entities are illustrated in FIG. 6, the number of sanctioned entities is not particularly limited, and there may be zero, one, two, three, or any number of sanctioned entities included in first table 614.

According to an exemplary embodiment, information of a sanctioned entity may be displayed in the details section 620. The details section 620 may display at least one of a full name 622 of the selected sanctioned entity, an image 624 of the selected sanctioned entity, a first image upload section 626, a second image upload section 628, a second table 630, an entity distribution field 632, and a third table 634.

In an exemplary embodiment, the second table 630 includes a field for at least one of a first name, a last name, a previous name, an alias, a citizenship, an additional citizenship, a country of birth, a city of birth, a date of birth, and an address. The third table 634 may include a field for at least one of politically exposed person, passport number, and country of residence. The entity distribution field may be a field that prompts a user to specify at least one entity that may access any information changed or added to details section 620.

In an exemplary embodiment, the details section 620 is used to view and/or add information relating to the selected sanctioned entity. A user of the user interface may be a due diligence personnel of a financial institution and may use the user interface to search for, find, and view details of a particular individual, company, organization, or group to aid in a decision whether to do business with the particular individual, company, organization, or group.

In an exemplary embodiment, a process of determining whether to do business with a particular individual, company, organization, group, or country on the basis of sanction information is performed without human intervention. For example, the Sanction Information Distribution module 302 may notify or flag a user of an organization, e.g., a financial institution, when the organization attempts to do business with a sanctioned entity in the database. In this regard, the Sanction Information Distribution module 302 may notify or flag the organization when the organization should further investigate the sanctioned entity identified in the database.

In an exemplary embodiment, when a user adds or modifies information in the details section 620, the user is prompted to save or cancel the added or modified information. As shown in FIG. 6, a save icon 636 and a cancel icon 640 may be included in the details section 620. When a user saves added or changed information, the saved information may be added to a distributed ledger, and/or may be distributed or made available to the entities or peers of the peer-to-peer network.

In an exemplary embodiment, a user is only able to add information in the details section 620, and the user is not able to modify existing information of the list section 610 and/or the details section 620. In an alternative exemplary embodiment, a user is able to add information to either or both of the list section 610 and the details section 620, and the user is also able to change or delete information on either or both of the list section 610 and the details section 620.

Accordingly, with this technology, an optimized process for distributing information relating to sanctions is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein tray broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for distributing information relating to sanctions, the method comprising:
receiving, from a governmental source, first information relating to at least one sanctioned entity;
arranging the first information according to a predetermined format; and
distributing the arranged first information to a plurality of financial institutions.

2. The method according to claim 1, further comprising
providing a user interface displaying the first information;
prompting a user to input second information that relates to the at least one sanctioned entity via the user interface;
receiving the second information;
arranging the second information according to the predetermined format; and
distributing the arranged second information to the plurality of financial institutions.

3. The method according to claim 2, wherein
the second information includes information relating to at least one from among at least one image associated with the at least one sanctioned entity, at least one International Bank Account Number (IBAN) associated with the at least one sanctioned entity, a passport number associated with the at least one sanctioned entity, and a country of residence of the at least one sanctioned entity.

4. The method according to claim 1, wherein
the at least one sanctioned entity is an individual person and the first information relating to the at least one sanctioned entity comprises at least one from among a name, an alias, at least one citizenship, a country of birth, a city of birth, an address, and a date of birth of the individual person.

5. The method according to claim 1, wherein
the at least one sanctioned entity is an organization and the first information relating to the at least one sanctioned entity comprises at least a name of the organization.

6. The method according to claim 1, wherein
the arranging of the first information comprises adding the information to a decentralized distributed ledger.

7. The method according to claim 1, wherein
the arranging of the first information comprises using blockchain technology to arrange the first information.

8. The method according to claim 1, wherein the first information includes at least one from among a list of sanctioned entities, a sanction list, and a black list of crypto wallets.

9. The method of claim 8, wherein the governmental source includes at least one from a United States Office of Foreign Asset Control (OFAC) and a State Secretariat for Economic Affairs (SECO).

10. A computing apparatus for distributing information relating to sanctions, the computing apparatus comprising:
a processor;
a memory; and
a communication interface coupled to each of the processor and the memory,
wherein the processor is configured to:
receive, from a governmental source, first information relating to at least one sanctioned entity;
arrange the first information according to a predetermined format; and
distribute the arranged first information to a plurality of financial institutions.

11. The computing apparatus according to claim 10, wherein the processor is further configured to:
provide a user interface displaying the first information;
prompt a user to input second information that relates to the at least one sanctioned entity via the user interface;
receive the second information;
arrange the second information according to the predetermined format; and distribute the arranged second information to the plurality of financial institutions.

12. The computing apparatus according to claim 11, wherein
the second information includes information relating to at least one from among at least one image associated with the at least one sanctioned entity, at least one International Bank Account Number (IBAN) associated with the at least one sanctioned entity, a passport number associated with the at least one sanctioned entity, and a country of residence of the at least one sanctioned entity.

13. The computing apparatus according to claim 10, wherein
the at least one sanctioned entity is an individual person and the first information relating to the at least one sanctioned entity comprises at least one from among a name, an alias, at least one citizenship, a country of birth, a city of birth, an address, and a date of birth of the individual person.

14. The computing apparatus according to claim 10, wherein
the at least one sanctioned entity is an organization and the first information relating to the at least one sanctioned entity comprises at least a name of the organization.

15. The computing apparatus according to claim 10, wherein
the arranging of the first information comprises adding the information to a decentralized distributed ledger.

16. The computing apparatus according to claim 10, wherein
the arranging of the first information comprises using blockchain technology to arrange the first information.

17. The computing apparatus according to claim 10, wherein the first information includes at least one from among a list of sanctioned entities, a sanction list, and a black list of crypto wallets.

18. The computing apparatus according to claim 10, wherein the governmental source includes at least one from a United States Office of Foreign Asset Control (OFAC) and a State Secretariat for Economic Affairs (SECO)

19. A non-transitory computer readable storage medium storing instructions for distributing information relating to sanctions, the storage medium comprising executable code which, when executed by a processor, causes the processor to:
receive, from a governmental source, first information relating to at least one sanctioned entity;
arrange the first information according to a predetermined format; and
distribute the arranged information to a plurality of financial institutions.

20. The storage medium according to claim 18, wherein when executed by the processor, the executable code further causes the processor to:
provide a user interface displaying the first information;
prompt a user to input second information that relates to the at least one sanctioned entity via the user interface;
receive the second information;
arrange the second information according to the predetermined format; and
distribute the arranged second information to the plurality of financial institutions.
